(19) United States
(12) Patent Application Publication
(10) Pub. No.: US 2014/0132500 A1
(43) Pub. Date: May 15, 2014

(54) METHOD AND APPARATUS FOR RECOGNIZING LOCATION OF MOVING OBJECT IN REAL TIME

(71) Applicants: Sang Chul AHN, Seoul (KR); Ig Jae KIM, Seoul (KR); Gyu-Chull HAN, Seoul (KR); Jaewon KIM, Seoul (KR)

(72) Inventors: Sang Chul AHN, Seoul (KR); Ig Jae KIM, Seoul (KR); Gyu-Chull HAN, Seoul (KR); Jaewon KIM, Seoul (KR)

(73) Assignee: KOREA INSTITUTE OF SCIENCE AND TECHNOLOGY, Seoul (KR)

(21) Appl. No.: 13/913,760

(22) Filed: Jun. 10, 2013

(30) Foreign Application Priority Data
Nov. 9, 2012 (KR) 10-2012-0126944

(51) Int. Cl. G06F 3/03

(52) U.S. Cl. CPC G06F 3/0325
USPC 345/156

(57) ABSTRACT

Provided is an apparatus for recognizing a location of a moving object in real time. The apparatus includes a lighting portion including a lighting unit for emitting a plurality of optical signals spatially separated in different patterns; an electronic tattoo portion that is attached on the moving object, wherein the electronic tattoo portion includes at least one electronic tattoo unit including a solar cell for detecting each of the plurality of optical signals emitted from the lighting portion, a wireless antenna for wirelessly transmitting the plurality of optical signals detected by the solar cell, and a controller for controlling the transmission of the plurality of optical signals; and a location recognition portion for recognizing the location of the moving object from the plurality of optical signals wirelessly transmitted from the electronic tattoo portion.

### CROSS-REFERENCE TO RELATED PATENT APPLICATION

This application claims the benefit of Korean Patent Application No. 10-2012-0126944, filed on Nov. 9, 2012, in the Korean Intellectual Property Office, the disclosure of which is incorporated herein in its entirety by reference.

### BACKGROUND OF THE INVENTION

1. Field of the Invention

The present invention relates to recognition of the location of a moving object, and more particularly, to a method and apparatus for recognizing a location of a moving object in real time by attaching an electronic tattoo on the moving object (for example, a human body) and wirelessly receiving a signal from the attached electronic tattoo.

2. Description of the Related Art

Recently, the need for technologies for recognizing a location of a human body or an object in real time to interact with digital information has increased with the development of information technology (IT) devices. As a typical example, “KINECT”, which was recently released by Microsoft, is an apparatus that recognizes a three-dimensional movement of a user and executes a game through interaction with digital content. In addition, as introduced in the movie “Minority Report”, a next generation technology for handling digital information on a screen through hand movements in the air has been commercialized as a technology called “G-Speak” by Oblong Industries. In the future, with the development of 3D TVs and internet protocol (IP) TVs, it is likely that it will be difficult to handle complicated digital information on a screen by using a conventional remote controller. Thus, a necessity to handle the complicated digital information on a screen through user movement at a long distance is gradually increasing.

However, conventional technologies have limitations in location measurement performance compared to price. “G-Speak” is a method of measuring the of an infrared optical detecting marker attached on a hand by using several high cost infrared cameras, and has high measurement accuracy but uses high cost equipment. “KINECT” uses a time-of-flight (TOF) type 3D measurement camera that is relatively inexpensive, but has low measurement accuracy. In addition, “KINECT” has low performance in measuring a location of a small object such as a hand at a long range.

### SUMMARY OF THE INVENTION

The present invention provides a method and apparatus for recognizing a location of a moving object in real time, which sense a space separation optical signal emitted from a light source through an electronic tattoo attached on an object such as a human body and wirelessly receive information sensed by the electronic tattoo so that an arithmetic operation unit may recognize the location of the moving object.

According to an aspect of the present invention, there is provided an apparatus for recognizing a location of a moving object in real time, the apparatus comprising a lighting portion comprising a lighting unit for emitting a plurality of optical signals spatially separated in different patterns; an electronic tattoo portion that is attached on the moving object, wherein the electronic tattoo portion comprises at least one electronic tattoo unit comprising a solar cell for detecting each of the plurality of optical signals emitted from the lighting portion, a wireless antenna for wirelessly transmitting the plurality of optical signals detected by the solar cell, and a controller for controlling the transmission of the plurality of optical signals; and a location recognition portion for recognizing the location of the moving object from the plurality of optical signals wirelessly transmitted from the electronic tattoo portion.

The lighting unit comprises a plurality of lighting devices each comprising a light source, a lighting polarization filter, and a space separation device.

The space separation device comprises a light transmission area and a light blocking area, which are separated by a bar code pattern with a predetermined space.

The plurality of lighting devices sequentially emits a plurality of optical signals spatially separated in different patterns.

The solar cell comprises a photoelectric cell module, a solar cell polarization filter corresponding to the lighting polarization filter, and a photo sensor.

The solar cell supplies a power supply to the electronic tattoo unit by using an external light source energy.

The lighting unit comprises a plurality of lighting devices each comprising a light source, a lighting band-pass filter, and a space separation device.

The space separation device comprises a light transmission area and a light blocking area, which are separated by a bar code pattern with a predetermined space.

The plurality of lighting devices sequentially emits a plurality of optical signals spatially separated in different patterns.

The solar cell comprises a photoelectric cell module, a solar cell band-pass filter corresponding to the lighting band-pass filter, and a photo sensor.

According to another aspect of the present invention, there is provided an apparatus for recognizing a location of a moving object in real time, the apparatus comprising: a lighting portion comprising a plurality of lighting units, each of which emits a plurality of optical signals spatially separated in different patterns; an electronic tattoo portion that is attached on the moving object, wherein the electronic tattoo portion comprises at least one electronic tattoo unit comprising a plurality of solar cells for detecting the plurality of optical signals emitted from the lighting portion, a wireless antenna for wirelessly transmitting the plurality of optical signals detected by the plurality of solar cells, and a controller for controlling the transmission of the plurality of optical signals; and a location recognition portion for recognizing the location of the moving object from the plurality of optical signals wirelessly transmitted from the electronic tattoo portion.

The lighting units respectively emit different polarization signals.

Each of the lighting units comprises a plurality of lighting devices each comprising a light source, a lighting polarization filter, and a space separation device, wherein the lighting polarization filter filters an optical signal emitted from the lighting source so that different polarization signals are emitted from the lighting units.

Each of the plurality of lighting units simultaneously or sequentially emits a plurality of optical signals spatially separated in different patterns.

Each of the plurality of solar cells comprises a photoelectric cell module, a solar cell polarization filter corresponding to the lighting polarization filter, and a photo sensor.

The lighting units respectively emit optical signals having different wavelength ranges.

Each of the lighting units comprises a plurality of lighting devices each comprising a light source, a lighting band-pass filter, and a space separation device, wherein the lighting band-pass filter filters an optical signal emitted from the lighting source so that optical signals having different wavelength ranges are emitted from the lighting units.

Each of the plurality of lighting units simultaneously or sequentially emits a plurality of optical signals spatially separated in different patterns.

Each of the plurality of solar cells comprises a photoelectric cell module, a solar cell band-pass filter corresponding to the lighting band-pass filter, and a photo sensor.

The number of solar cells is the same as that of lighting units.

According to another aspect of the present invention, there is provided a method of recognizing a location of a moving object in real time, the method comprising: emitting a plurality of optical signals spatially separated in different patterns by using a lighting portion; by using an electronic tattoo portion, detecting the plurality of optical signals emitted from the lighting portion and transmitting the detected plurality of optical signals wirelessly, wherein the electronic tattoo portion is attached on the moving object and comprises at least one electronic tattoo unit comprising a solar cell for detecting each of the plurality of optical signals emitted from the lighting portion, a wireless antenna for wirelessly transmitting the plurality of optical signals detected by the solar cell, and a controller for controlling the transmission of the plurality of optical signals; and recognizing the location of the moving object from the plurality of optical signals wirelessly transmitted from the electronic tattoo portion by using a location recognition portion.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of an apparatus for recognizing a location of a moving object in real time wirelessly, according to an embodiment of the present invention;

FIG. 2 is a diagram illustrating an example of a lighting unit illustrated in FIG. 1;

FIG. 3 is a diagram illustrating a light source and a lighting polarization filter, which are components of a lighting device illustrated in FIG. 2;

FIG. 4 is a diagram illustrating patterns of space separation devices illustrated in FIG. 2;

FIG. 5 is a diagram illustrating a solar cell, a wireless antenna, and a controller, which constitute an electronic tattoo unit;

FIG. 6 is a diagram illustrating a photoelectric cell module, a solar cell polarization filter (or a solar cell bandpass filter), and a photo sensor, which constitute a solar cell;

FIG. 7A is a diagram illustrating a solar cell polarization filter of a solar cell;

FIG. 7B is a diagram illustrating a solar cell bandpass filter of a solar cell;

FIG. 8 is a diagram illustrating optical signals that are emitted through the space separation devices illustrated in FIG. 2;

FIG. 9 is a diagram illustrating results sensed by an electronic tattoo unit with respect to optical signals emitted through a space separation devices illustrated in FIG. 8;

FIG. 10 is a block diagram of an apparatus for recognizing a location of a moving object in real time wirelessly, according to another embodiment of the present invention; and

FIG. 11 is a flowchart illustrating a method of recognizing a location of a moving object in real time wirelessly, according to an embodiment of the present invention.

### DETAILED DESCRIPTION OF THE INVENTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description.

Expressions such as “at least one of,” when preceding a list of elements, modify the entire list of elements and do not modify the individual elements of the list.

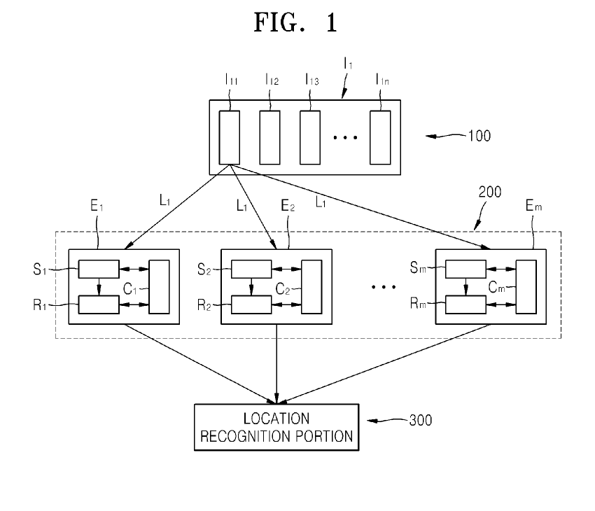

FIG. 1 is a block diagram of an apparatus for recognizing a location of a moving object in real time wirelessly, according to an embodiment of the present invention. Referring to FIG. 1, the apparatus includes a lighting portion 100, an electronic tattoo portion 200, and a location recognition portion 300.

The lighting portion 100 includes a lighting unit I₁ for emitting optical signals spatially separated in different patterns. The lighting unit I₁ includes a plurality of lighting devices I₁₁, I₁₂, . . . , I₁ₙ, and each of the plurality of lighting devices I₁₁, I₁₂, . . . , I₁ₙ includes a light source, a lighting polarization filter, and a space separation device.

Each of the plurality of lighting devices I₁₁, I₁₂, . . . , I₁ₙ of the lighting unit I₁ emits a plurality of optical signals spatially separated in different patterns (where “n” is a natural number that is greater than 1).

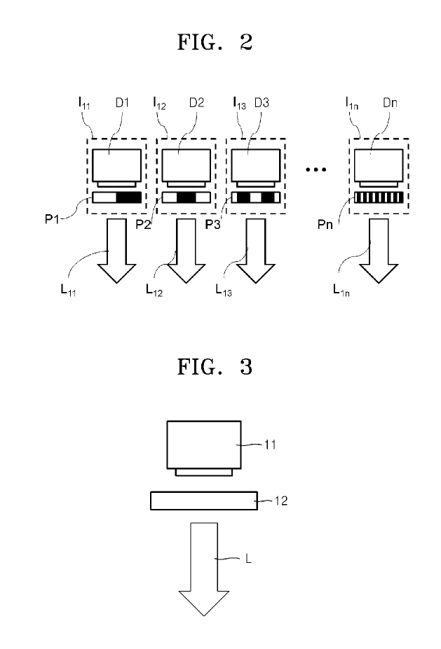

FIG. 2 is a diagram illustrating an example of the lighting unit I₁ illustrated in FIG. 1. Referring to FIG. 2, each of the plurality of lighting devices I₁₁, I₁₂, . . . , I₁ₙ constituting the lighting unit I₁ includes one light source and one space separation device as a pair. That is, the lighting device I₁₁ includes a light source D1 and a space separation device P1, the lighting device I₁₂ includes a light source D2 and a space separation devices P2. In the same manner, the lighting device I₁ₙ includes a light source Dn and a space separation device Pn. The n light sources D1, D2, . . . , Dn emit lights having the same wavelength range λ₁. Each of the light sources D1, D2, . . . , Dn may be a light-emitting device emitting a narrowband light, such as a light-emitting diode (LED).

Each of the light sources D1, D2, . . . , Dn illustrated in FIG. 2 may include a light source 11, which emits a broadband light, and a lighting polarization filter 12 that is disposed at an output side of the light source 11, as illustrated in FIG. 3. In this case, since the lighting polarization filter 12 is an optical filter for passing only a linearly polarized light in a specific direction, the broadband light emitted from the light source 11 is filtered through the lighting polarization filter 12 to thereby output light having a specific polarization.

A lighting band-pass filter may be disposed instead of the lighting polarization filter 12 illustrated in FIG. 3. In this case, since the lighting band-pass filter is an optical filter that uses only a specific wavelength range as a passband, the broadband light emitted from the light source 11 is filtered through the lighting band-pass filter to thereby output light having a specific wavelength range.

Each of the space separation devices P1, P2, . . . , Pn may be formed of, for example, a transparent film on which a space separation pattern is printed. The space separation devices P1, P2, . . . , Pn are disposed at light-emitting sides of the light sources D1, D2, . . . , Dn, respectively, and spatially separate lights emitted from the light sources D1, D2, . . . , Dn in different patterns.

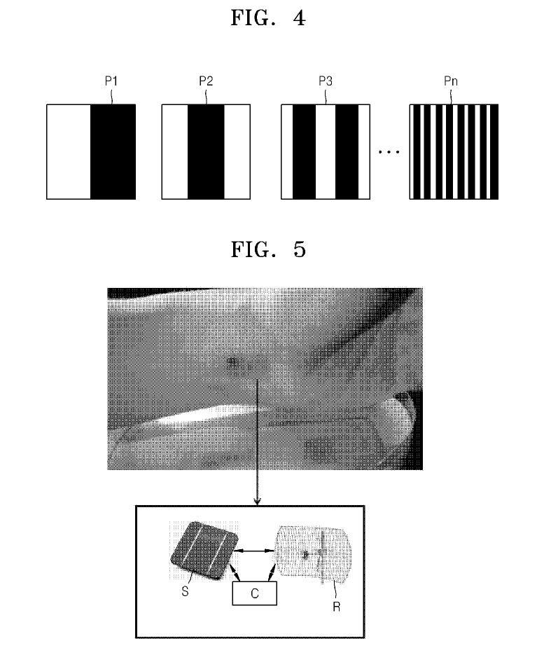

FIG. 4 is a diagram illustrating patterns of the space separation devices P1, P2, . . . , Pn illustrated in FIG. 2. Referring to FIG. 4, a first space separation device, namely, the space separation device P1, has a one-dimensional bar code pattern in which a space is separated into two areas in one direction. In this case, a white area of the two areas is a light transmission area, and a black area of the two areas is a light blocking area. In the same manner, a second space separation device, namely, the space separation device P2, has a one-dimensional bar code pattern in which a space is separated into three areas in one direction, a third space separation device, namely, the space separation device P3, has a one-dimensional bar code pattern in which a space is separated into four areas in one direction, and a n-th space separation device, namely, the space separation device Pn, has a one-dimensional bar code pattern in which a space is separated into (n+1) areas in one direction. Consequently, a minimum interval of the first through n-th space separation devices P1, P2, . . . , Pn (that is, an interval of the bar code pattern of the n-th space separation device Pn) determines a resolution of a location to be detected. Accordingly, if it is desired to more exactly trace a location, it is necessary to further shorten the minimum interval of the first through n-th space separation devices P1, P2, . . . , Pn. The one-dimensional bar code patterns of the space separation devices P1, P2, . . . , Pn are described as an example for convenience of explanation, and the present invention is not limited thereto. For example, the space separation devices P1, P2, . . . , Pn may have two-dimensional bar code patterns in which a space is separated into two directions.

The lighting devices I₁₁, I₁₂, . . . , I₁ₙ of the lighting unit I₁ sequentially emit the plurality of optical signals spatially separated in different patterns to the electronic tattoo portion 200.

The electronic tattoo portion 200 is attached on a moving object. The electronic tattoo portion 200 includes at least one electronic tattoo unit that includes a solar cell for detecting each of the plurality of optical signals that are emitted from the lighting portion 100, a wireless antenna for wirelessly transmitting the plurality of optical signals detected by the solar cell, and a controller for controlling the transmission of the plurality of optical signals. The electronic tattoo portion 200 of FIG. 1 includes m electronic tattoo units E₁, E₂, . . . , Eₘ that are attached on an object (where m is equal to or greater than 1).

As illustrated in FIG. 1, the electronic tattoo units E₁, E₂, . . . , Eₘ respectively include solar cells S₁, S₂, . . . , Sₘ, wireless antennas R₁, R₂, . . . , Rₘ, and controllers C₁, C₂, . . . , Cₘ. FIG. 5 is a diagram illustrating a solar cell S, a wireless antenna R, and a controller C, which constitute each electronic tattoo unit.

Each of the solar cells S₁, S₂, . . . , Sₘ uses light source energy obtained from an external lighting as power, and receives the spatially separated plurality of optical signals emitted from the lighting portion 100. To this end, each of the solar cells S₁, S₂, . . . , Sₘ includes a photoelectric cell module, a solar cell polarization filter (or a solar cell band-pass filter), and a photo sensor.

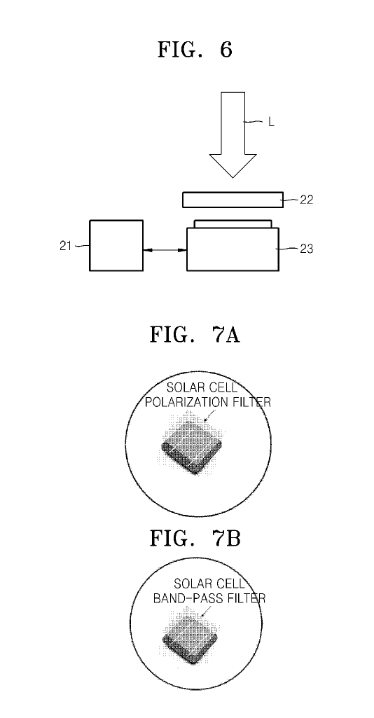

FIG. 6 is a diagram illustrating a photoelectric cell module 21, a solar cell polarization filter 22 (or a solar cell band-pass filter), and a photo sensor 23, which constitute each solar cell. FIG. 7A is a diagram illustrating a solar cell polarization filter of a solar cell, and FIG. 7B is a diagram illustrating a solar cell band-pass filter of a solar cell.

The photoelectric cell module 21 is a module for generating a photoelectron-motive force by a photoelectric effect when light is emitted from a light source such as the sun or a lighting thereto, and converts light energy into electric energy. The photoelectric cell module 21 supplies a power supply, which is needed by an electronic tattoo unit, by using a light source such as the sun or a lighting.

The solar cell polarization filter 22 is a filter having a polarization direction corresponding to a polarization direction of the lighting polarization filter 12, and only an optical signal having a specific polarization direction from among incident optical signals passes through the solar cell polarization filter 22 and thus is transmitted to the photo sensor 23.

A solar cell band-pass filter instead of the solar cell polarization filter 22 may be included in each solar cell. Since the solar cell band-pass filter is an optical filter that uses only a specific wavelength range as a passband, only an optical signal of a corresponding wavelength range from among incident optical signals passes through the solar cell band-pass filter and thus is transmitted to the photo sensor 23.

The photo sensor 23 senses an optical signal filtered by the solar cell polarization filter 22 (or the solar cell band-pass filter).

Each of the wireless antennas R₁, R₂, . . . , Rₘ wirelessly transmits a plurality of optical signals, which are sensed by each of the solar cells S₁, S₂, . . . , Sₘ, to the location recognition portion 300. Each of the wireless antennas R₁, R₂, . . . , Rₘ shares identification information for identifying each wireless antenna with the location recognition portion 300 to transmit the optical signals to the location recognition portion 300.

Each of the controllers C₁, C₂, . . . , Cₘ controls the transmission of the plurality of optical signals sensed by each of the solar cells S₁, S₂, . . . , Sₘ to the location recognition portion 300 through each of the wireless antennas R₁, R₂, . . . , Rₘ. That is, when the lighting devices I₁₁, I₁₂, . . . , I₁ₙ of the lighting unit I₁ sequentially transmit the plurality of optical signals spatially separated in different patterns to the electronic tattoo portion 200, the controllers C₁, C₂, . . . , Cₘ respectively control the wireless antennas R₁, R₂, . . . , Rₘ to sequentially transmit the plurality of optical signals sensed by each of the solar cells S₁, S₂, . . . , Sₘ to the location recognition portion 300.

The location recognition portion 300 recognizes the location of an object from optical signals wirelessly transmitted from the electronic tattoo portion 200. To this end, the location recognition portion 300 includes a wireless reception antenna for receiving the optical signals transmitted from the electronic tattoo portion 200. In addition, the location recognition portion 300 stores information about a relation function or lookup table between prescribed binary codes and location coordinates in a predetermined memory (not shown).

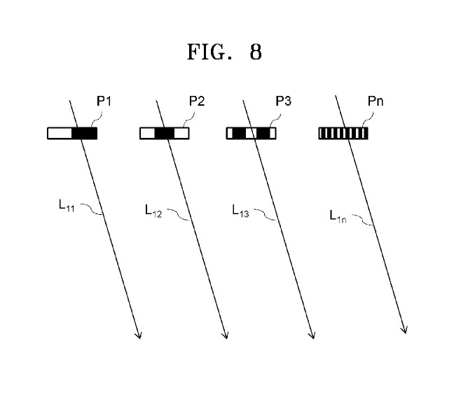

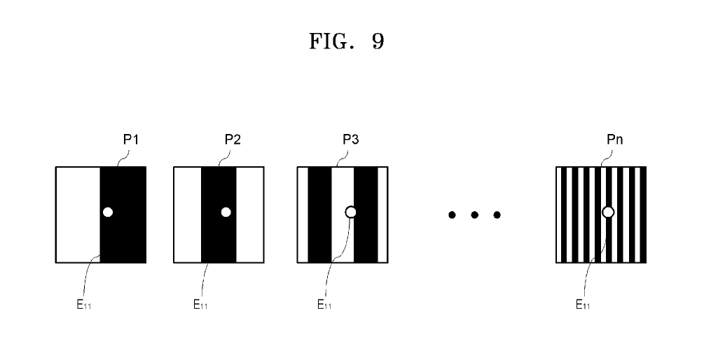

A detailed function of the location recognition portion 300 is described with reference to FIGS. 8 and 9.

FIG. 8 is a diagram illustrating optical signals that are emitted through the space separation devices P1, P2, . . . , Pn illustrated in FIG. 2. FIG. 9 is a diagram illustrating results sensed by the electronic tattoo unit E₁ with respect to optical signals emitted through the space separation devices P1, P2, . . . , Pn illustrated in FIG. 8.

First, the m electronic tattoo units E₁, E₂, . . . , Eₘ are attached on portions of an object (for example, the head, shoulder, arm, hand, and leg of a human body) whose real time location is to be traced. The lighting unit I₁ is disposed towards the object.

Next, the lighting unit I₁ sequentially emits a plurality of optical signals spatially separated in different patterns. That is, the lighting unit I₁ sequentially emits a plurality of optical signals L₁₁, L₁₂, . . . , L₁ₙ that have an arbitrary wavelength range and are spatially separated in different patterns P1, P2, . . . , Pn.

Since the plurality of optical signals L₁₁, L₁₂, . . . , L₁ₙ that are sequentially emitted from the lighting unit I₁ are spatially separated in different patterns, location coordinate values of positions where the electronic tattoo units E₁, E₂, . . . , Eₘ have been attached may be obtained by detecting the plurality of optical signals L₁₁, L₁₂, . . . , L₁ₙ.

Referring to FIGS. 8 and 9, when the plurality of optical signals L₁₁, L₁₂, . . . , L₁ₙ are sequentially emitted from the lighting unit I₁, a first electronic tattoo unit, namely, the electronic tattoo unit E₁, sequentially detects the plurality of optical signals L₁₁, L₁₂, . . . , L₁ₙ. In this case, a first optical signal L₁₁ is emitted to a bar code pattern of the first space separation device P1, and thus, the first optical signal L₁₁ is not detected at a location where the first electronic tattoo unit E1 is located. That is, the first optical signal L₁₁ is detected as a “0” level signal at the location where the first electronic tattoo unit E1 is located. A second optical signal L₁₂ that is emitted to a bar code pattern of the second space separation device P2 is detected as a “0” level signal at the location where the first electronic tattoo unit E1 is located. However, a third optical signal L₁₃ that is emitted to a bar code pattern of the third space separation device P3 is detected as a “1” level signal at the location where the first electronic tattoo unit E1 is located. In this manner, the first electronic tattoo unit E₁ sequentially detects the plurality of optical signals L₁₁, L₁₃, . . . L₁ₙ spatially separated in different patterns, and wirelessly transmits signal values of the detected optical signals L₁₁, L₁₃, . . . , L₁ₙ to the location recognition portion 300. Since the plurality of optical signals L₁₁, L₁₃, . . . , L₁ₙ are spatially separated in different patterns, the signal values of the detected plurality of optical signals L₁₁, L₁₃, . . . , L₁ₙ are changed if the location of the first electronic tattoo unit E1 moves. Accordingly, the signal values of the detected plurality of optical signals L₁₁, L₁₃, . . . , L₁ₙ have information about the location of the first electronic tattoo unit E₁. Thus, the location recognition portion 300 processes the signal values of the plurality of optical signals L₁₁, L₁₃, . . . , L₁ₙ detected in the first electronic tattoo unit E₁, and thus generates a binary code (for example, 00100). In addition, the location recognition portion 300 recognizes the location of the first electronic tattoo unit E₁ by calculating a location coordinate value of the first electronic tattoo unit E₁ from the relation function or lookup table between prescribed binary codes and location coordinate values by using the generated binary code.

In the same manner, the location recognition portion 300 changes optical signals transmitted from the electronic tattoo units E₁, E₂, . . . , Eₘ into binary codes, and may recognize the locations of the electronic tattoo units E₁, E₂, . . . , Eₘ by comparing the binary codes with the lookup table of the location coordinate values.

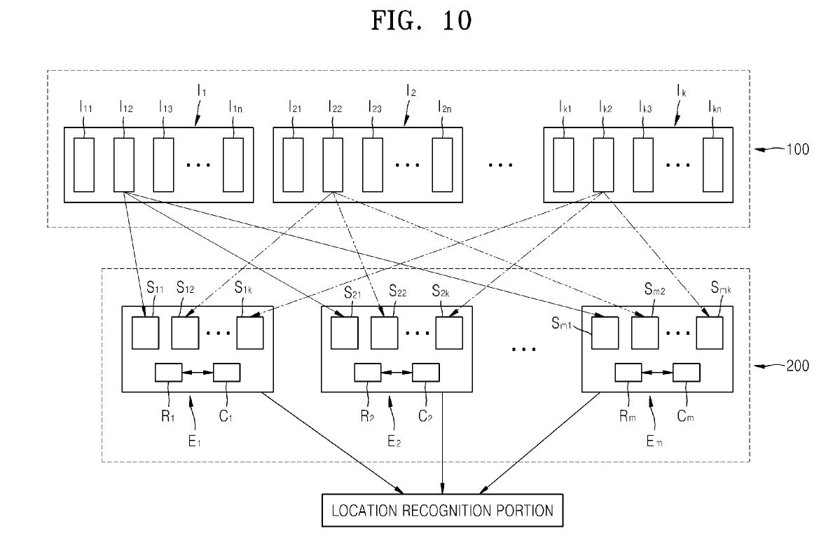

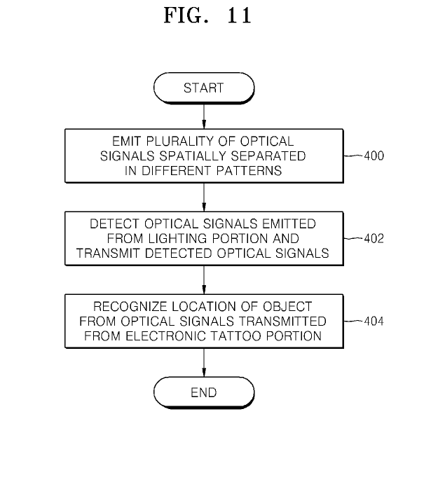

FIG. 10 is a block diagram of an apparatus for recognizing a location of a moving object in real time wirelessly, according to another embodiment of the present invention. The apparatus of FIG. 10 is only different from that of FIG. 1 in that a light portion 100 has a plurality of lighting units and each of electronic tattoo units E₁, E₂, . . . , Eₘ of an electronic tattoo portion 200 has a plurality of solar cells. Thus, below, repeated descriptions of elements that have already been described above are omitted.

The lighting portion 100 includes k lighting units I₁, I₂, . . . , Iₖ for emitting polarization signals having different polarization directions or optical signals having different wavelength ranges λ₁, λ₂, . . . , λₖ at different locations. “k” is a natural number that is greater than 1. Each of the lighting units I₁, I₂, . . . , Iₖ simultaneously or sequentially emits a plurality of optical signals spatially separated in different patterns.

The different polarization directions means that linear polarization directions are different at the k lighting units I₁, I₂, . . . , Iₖ. The different wavelength ranges λ₁, λ₂, . . . , λₖ means that wavelength ranges having ±Δ bandwidth with respect to central wavelengths λ₁, λ₂, . . . , λₖ, do not substantially overlap each other and wavelength ranges of the k lighting units I₁, I₂, . . . , Iₖ differ. The number of lighting units I₁, I₂, . . . , Iₖ is equal to that of degrees of freedom to be detected.

Each of the lighting units I₁, I₂, . . . , Iₖ includes a plurality of lighting devices I₁₁, I₁₂, . . . , I₁ₙ that each emit a plurality of optical signals which have the same polarization direction or wavelength range and are spatially separated in different patterns. That is, the lighting unit I₁ includes a plurality of lighting devices I₁₁, I₁₂, . . . , I₁ₙ, and the lighting unit I₂ includes a plurality of lighting devices I₂₁, I₂₂, . . . , I₂ₙ. In this manner, the lighting unit Iₖ includes a plurality of lighting devices Iₖ₁, Iₖ₂, . . . , Iₖₙ. “n” is a natural number that is greater than 1.

Referring to FIG. 2, each of the n lighting devices I₁₁, I₁₂, . . . , I₁ₙ constituting the lighting unit I₁ includes one light source and one space separation device as a pair. That is, the lighting device I₁₁ includes a light source D1 and a space separation device P1, and the lighting device I₁₂ includes a light source D2 and a space separation device P2. In the same manner, the lighting device I₁ₙ includes a light source Dn and a space separation device Pn. The n light sources D1, D2, . . . , Dn emit light having the same polarization direction or the same wavelength range λ₁. The other lighting units I₂, . . . , Iₖ have substantially the same structure as the lighting unit I₁ except that a polarization direction or wavelength range of a plurality of optical signals which are emitted from each of the lighting units I₂, . . . , Iₖ is different from that of the plurality of optical signals which are emitted from the lighting unit I₁.

The electronic tattoo portion 200 includes m electronic tattoo units E₁, E₂, . . . , Eₘ that are attached on an object. Each of the electronic tattoo units E₁, E₂, . . . , Eₘ includes a plurality of solar cells, a single wireless antenna, and a single controller. That is, a first electronic tattoo unit, namely, the electronic tattoo unit E₁, includes k solar cells S₁₁, S₁₂, . . . , S₁ₖ, the number of which is equal to that of lighting units I₁, I₂, . . . , Iₖ, a single wireless antenna R₁, and a single controller C₁. A second electronic tattoo unit, namely, the electronic tattoo unit E₂, includes k solar cells S₂₁, S₂₂, . . . , S₂ₖ, the number of which is equal to that of lighting units I₁, I₂, . . . , Iₖ, a single wireless antenna R₂, and a single controller C₂. In this manner, an m-th electronic tattoo unit, namely, the electronic tattoo unit Eₘ, includes k solar cells Sₘ₁, Sₘ₂, . . . , Sₘₖ, the number of which is equal to that of lighting units I₁, I₂, . . . , Iₖ, a single wireless antenna Rₘ, and a single controller Cₘ.

Each of k solar cells of each electronic tattoo unit (for example, each of the solar cells S₁₁, S₁₂, . . . , S₁ₖ of the electronic tattoo unit E₁) has a solar cell polarization filter for detecting polarization signals corresponding to different polarization directions of optical signals that are emitted from the plurality of lighting units I₁, I₂, . . . , Iₖ, or has a solar cell bandpass filter for detecting wavelength bands corresponding to different wavelength ranges λ₁, λ₂, . . . , λₖ of the optical signals that are emitted from the plurality of lighting units I₁, I₂, . . . , Iₖ.

Accordingly, since the solar cell polarization filter is an optical filter for passing only an optical signal having a specific polarization direction, only an optical signal having the specific polarization direction from among incident optical signals passes through the solar cell polarization filter and thus is detected by an optical sensor. In addition, since the solar cell band-pass filter is an optical filter that uses only a specific wavelength range as a passband, only an optical signal of the specific wavelength range from among incident optical signals passes through the solar cell band-pass filter and thus is detected by the optical sensor.

Each electronic tattoo unit detects a location where each electronic tattoo unit has been attached. For example, the electronic tattoo unit E₁ detects a location where the electronic tattoo unit E₁ has been attached. K solar cells of each electronic tattoo unit are used for recognizing k degrees of freedom at a location where each electronic tattoo unit has been attached. For example, K solar cells S₁₁, S₁₂, . . . , S₁ₖ of the electronic tattoo unit E₁ are used for recognizing k degrees of freedom at a location where the electronic tattoo unit E₁ has been attached. If three solar cells (for example, S₁₁, S₁₂, and S₁₃) are disposed in the electronic tattoo unit E₁, X, Y, and Z coordinates of the location where the electronic tattoo unit E₁ has been attached may be detected.

The location recognition portion 300 processes optical signal values transmitted from the electronic tattoo portion 200, and converts the processed optical signal values into location coordinate values. For example, if the m tattoo units E₁, E₂, . . . , Eₘ, are attached on portions of an object, a real time location of which is to be traced, the k lighting units I₁, I₂, . . . , Iₖ are disposed to light at different locations centered on the object.

Next, each of the k lighting units I₁, I₂, . . . , Iₖ sequentially emits a plurality of optical signals that have the same polarization direction or the same wavelength range and are spatially separated in different patterns. For example, a first lighting unit I₁ sequentially emits a plurality of optical signals that have a specific linear polarization or λ₁ wavelength range and are spatially separated in different patterns (P1, P2, . . . , Pn). The other lighting units I₂, . . . , Iₖ also each sequentially emit a plurality of optical signals. The k lighting units I₁, I₂, . . . , Iₖ are driven at the same time. For example, as illustrated in FIG. 10, when a second lighting device I₁₂ of the first lighting unit I₁ emits an optical signal, second lighting devices I₂₂, . . . , Iₖ₂ of the other lighting units I₂, . . . , Iₖ also emit optical signals at the same time. In this manner, as the k lighting units I₁, I₂, . . . , Iₖ light at the same time, a time that is required for the whole lighting portion 100 to light during one period (that is, a time that is required for each of the total n×k lighting devices I₁₁, I₁₂, . . . , I₁ₙ; I₂₁, I₂₂, . . . , I₂ₙ; . . . , Iₖ₁, Iₖ₂, . . . , Iₖₙ to light once) is the same as that that is required for one lighting unit (for example, I₁) to light during the one period.

Since a plurality of optical signals that are sequentially emitted from each of the k lighting units I₁, I₂, . . . , Iₖ are spatially separated in different patterns, location coordinate values of positions where the electronic tattoo units E₁, E₂, . . . , Eₘ have been attached may be obtained by detecting the plurality of optical signals.

Referring back to FIGS. 8 and 9, when the plurality of optical signals L₁₁, L₁₃, . . . , L₁ₙ are sequentially emitted from the first lighting unit I₁, since the plurality of optical signals L₁₁, L₁₃, . . . , L₁ₙ that are emitted from the first lighting unit I₁ have a specific polarization direction or a specific wavelength range (for example, λ₁), a first solar cell S₁₁ of the first electronic tattoo unit E₁ sequentially detects the plurality of optical signals L₁₁, L₁₃, . . . , L₁ₙ. In this case, a first optical signal L₁₁ is emitted to a bar code pattern of the first space separation device P1, and thus, the first optical signal L₁₁ is not detected at a location where the first solar cell S₁₁ of the first electronic tattoo unit E1 is located. That is, the first optical signal L₁₁ is detected as a “0” level signal at the location where the first solar cell S₁₁ of the first electronic tattoo unit E1 is located. A second optical signal L₁₂ that is emitted to a bar code pattern of the second space separation device P2 is detected as a “0” level signal at the location where the first solar cell S₁₁ of the first electronic tattoo unit E1 is located. However, a third optical signal L₁₃ that is emitted to a bar code pattern of the third space separation device P3 is detected as a “1” level signal at the location where the first solar cell S₁₁ of the first electronic tattoo unit E1 is located. In this manner, the first solar cell S₁₁ of the first electronic tattoo unit E₁ sequentially detects the plurality of optical signals L₁₁, L₁₃, . . . , L₁ₙ spatially separated in different patterns, and wirelessly transmits signal values of the detected optical signals L₁₁, L₁₃, . . . , L₁ₙ to the location recognition portion 300. The signal values of the detected plurality of optical signals L₁₁, L₁₃, . . . , L₁ₙ have information about the location of the first solar cell S₁₁ of the first electronic tattoo unit E₁. The location recognition portion 300 processes the signal values of the plurality of optical signals L₁₁, L₁₃, . . . , L₁ₙ detected in the first solar cell S₁₁ of the first electronic tattoo unit E₁, and thus generates a binary code (for example, 00100). In addition, the location recognition portion 300 calculates a first location coordinate value of the first electronic tattoo unit E₁ from a relation function or lookup table between prescribed binary codes and location coordinate values by using the generated binary code.

In the same manner, a second solar cell S₁₂ of the first electronic tattoo unit E₁ detects a plurality of optical signals L₂₁, L₂₃, . . . , L₂ₙ that are emitted from the second lighting unit I₂, and sends the detected plurality of optical signals to the location recognition portion 300. The location recognition portion 300 calculates a second location coordinate value of the first electronic tattoo unit E₁ from the plurality of optical signals L₂₁, L₂₃, . . . , L₂ₙ detected by the second solar cell S₁₂ of the first electronic tattoo unit E₁. In the same manner, a k-th solar cell S₁ₖ of the first electronic tattoo unit E₁ detects a plurality of optical signals Lₖ₁, Lₖ₃, . . . , Lₖₙ that are emitted from the k-th lighting unit Iₖ, and the location recognition portion 300 calculates a k-th location coordinate value of the first electronic tattoo unit E₁ from the plurality of optical signals Lₖ₁, Lₖ₃, . . . , Lₖₙ detected by the k-th solar cell S₁ₖ of the first electronic tattoo unit E₁. In this case, the first location coordinate value, the second location coordinate value, . . . , the k-th location coordinate value indicate components of location coordinates having k degrees of freedom of the first electronic tattoo unit E₁. That is, the number of lighting units I₁, I₂, . . . , Iₖ is the same as that of solar cells (for example, S₁₁, S₁₂, . . . , S₁ₖ) located in one electronic tattoo unit (for example, E1), and is the same as the degree of freedom of a location to be detected. If k is three, a three-dimensional coordinate value of a location where the first electronic tattoo unit E₁ has been attached may be obtained.

When m electronic tattoo units E₁, E₂, . . . , Eₘ, are attached on an object in the manner stated above, a real time location coordinate value of a location where the electronic tattoo units E₁, E₂, . . . , Eₘ, have been attached may be obtained.

When the degree of freedom of an object location increases, the number of lighting units increases. If the lighting units I₁, I₂, . . . , Iₖ emit optical signals having the same polarization direction or the same wavelength range, the lighting units I₁, I₂, . . . , Iₖ should sequentially light to separate the optical signals. Thus, when the lighting units I₁, I₂, . . . , Iₖ emit optical signals having the same polarization direction or the same wavelength range, a time that is required for the lighting units I₁, I₂, . . . , Iₖ to light increases as the degree of freedom of the object location increases. Thus, a recognition speed is lowered, thereby causing a limitation in recognizing the location of an object in real time. On the other hand, according to the current embodiment, since the lighting units I₁, I₂, . . . , Iₖ are driven at the same time, a time that is required for the lighting units I₁, I₂, . . . , Iₖ to light does not increase although the degree of freedom of the object location increases, and thus, a real time recognition of the location of an object is facilitated.

FIG. 11 is a flowchart illustrating a method of recognizing a location of a moving object in real time wirelessly, according to an embodiment of the present invention.

First, a lighting portion emits a plurality of optical signals spatially separated in different patterns (operation 400). A process in which the lighting portion emits a plurality for optical signals is the same as described above, and thus, detailed description is omitted.

After operation 400, an electronic tattoo portion detects the plurality of optical signals emitted from the lighting portion, and transmits the detected plurality of optical signals to a location recognition portion (operation 402). The electronic tattoo portion is attached on a moving object, wherein the electronic tattoo portion includes at least one electronic tattoo unit that includes at least one solar cell, a wireless antenna for wirelessly transmitting the plurality of optical signals which are detected by the at least one solar cell, and a controller for controlling the transmission of the plurality of optical signals. A process in which the electronic tattoo portion detects a plurality of optical signals and transmits a signal corresponding to location coordinate values of the detected plurality of optical signals to the location recognition portion is the same as described above, and thus, detailed description is omitted.

After operation 402, the location recognition portion recognizes the location of the moving object from the optical signals wirelessly transmitted from the electronic tattoo portion (operation 404). A process in which the location recognition portion recognizes the location of the moving object from binary-coded information of location coordinate values of the optical signals, which is provided from the electronic tattoo portion, is the same as described above, and thus, detailed description is omitted.

According to the present invention, the real time location of a moving object may be recognized wirelessly.

In addition, high resolution location detection is possible at low cost by using a photo sensor of an electronic tattoo and increasing the accuracy of measuring a location through spatially separated optical signals that are emitted from a lighting portion.

In addition, due to the use of the electronic tattoo, the location of an object may be wirelessly recognized by using external lighting energy without a power supply.

The invention can also be embodied as computer-readable codes on a computer-readable recording medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, and optical data storage devices.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for recognizing a location of a moving object in real time, the apparatus comprising:
a lighting portion comprising a lighting unit for emitting a plurality of optical signals spatially separated in different patterns;
an electronic tattoo portion that is attached on the moving object, wherein the electronic tattoo portion comprises at least one electronic tattoo unit comprising a solar cell for detecting each of the plurality of optical signals emitted from the lighting portion, a wireless antenna for wirelessly transmitting the plurality of optical signals detected by the solar cell, and a controller for controlling the transmission of the plurality of optical signals; and
a location recognition portion for recognizing the location of the moving object from the plurality of optical signals wirelessly transmitted from the electronic tattoo portion.

2. The apparatus of claim 1, wherein the lighting unit comprises a plurality of lighting devices each comprising a light source, a lighting polarization filter, and a space separation device.

3. The apparatus of claim 2, wherein the space separation device comprises a light transmission area and a light blocking area, which are separated by a bar code pattern with a predetermined space.

4. The apparatus of claim 2, wherein the plurality of lighting devices sequentially emit a plurality of optical signals spatially separated in different patterns.

5. The apparatus of claim 2, wherein the solar cell comprises a photoelectric cell module, a solar cell polarization filter corresponding to the lighting polarization filter, and a photo sensor.

6. The apparatus of claim 1, wherein the solar cell supplies a power supply to the electronic tattoo unit by using an external light source energy.

7. The apparatus of claim 1, wherein the lighting unit comprises a plurality of lighting devices each comprising a light source, a lighting band-pass filter, and a space separation device.

8. The apparatus of claim 7, wherein the space separation device comprises a light transmission area and a light blocking area, which are separated by a bar code pattern with a predetermined space.

9. The apparatus of claim 7, wherein the plurality of lighting devices sequentially emit a plurality of optical signals spatially separated in different patterns.

10. The apparatus of claim 7, wherein the solar cell comprises a photoelectric cell module, a solar cell band-pass filter corresponding to the lighting band-pass filter, and a photo sensor.

11. An apparatus for recognizing a location of a moving object in real time, the apparatus comprising:
a lighting portion comprising a plurality of lighting units, each of which emits a plurality of optical signals spatially separated in different patterns;
an electronic tattoo portion that is attached on the moving object, wherein the electronic tattoo portion comprises at least one electronic tattoo unit comprising a plurality of solar cells for detecting the plurality of optical signals emitted from the lighting portion, a wireless antenna for wirelessly transmitting the plurality of optical signals detected by the plurality of solar cells, and a controller for controlling the transmission of the plurality of optical signals; and
a location recognition portion for recognizing the location of the moving object from the plurality of optical signals wirelessly transmitted from the electronic tattoo portion.

12. The apparatus of claim 11, wherein the lighting units respectively emit different polarization signals.

13. The apparatus of claim 12, wherein each of the lighting units comprises a plurality of lighting devices each comprising a light source, a lighting polarization filter, and a space separation device,
wherein the lighting polarization filter filters an optical signal emitted from the lighting source so that different polarization signals are emitted from the lighting units.

14. The apparatus of claim 11, wherein each of the plurality of lighting units simultaneously or sequentially emits a plurality of optical signals spatially separated in different patterns.

15. The apparatus of claim 13, wherein each of the plurality of solar cells comprises a photoelectric cell module, a solar cell polarization filter corresponding to the lighting polarization filter, and a photo sensor.

16. The apparatus of claim 11, wherein the lighting units respectively emit optical signals having different wavelength ranges.

17. The apparatus of claim 16, wherein each of the lighting units comprises a plurality of lighting devices each comprising a light source, a lighting band-pass filter, and a space separation device,
wherein the lighting band-pass filter filters an optical signal emitted from the lighting source so that optical signals having different wavelength ranges are emitted from the lighting units.

18. The apparatus of claim 11, wherein each of the plurality of lighting units simultaneously or sequentially emits a plurality of optical signals spatially separated in different patterns.

19. The apparatus of claim 17, wherein each of the plurality of solar cells comprises a photoelectric cell module, a solar cell band-pass filter corresponding to the lighting band-pass filter, and a photo sensor.

20. The apparatus of claim 11, wherein the number of solar cells is the same as that of lighting units.

21. A method of recognizing a location of a moving object in real time, the method comprising:
emitting a plurality of optical signals spatially separated in different patterns by using a lighting portion;
by using an electronic tattoo portion, detecting the plurality of optical signals emitted from the lighting portion and transmitting the detected plurality of optical signals wirelessly, wherein the electronic tattoo portion is attached on the moving object and comprises at least one electronic tattoo unit comprising a solar cell for detecting each of the plurality of optical signals emitted from the lighting portion, a wireless antenna for wirelessly transmitting the plurality of optical signals detected by the solar cell, and a controller for controlling the transmission of the plurality of optical signals; and
recognizing the location of the moving object from the plurality of optical signals wirelessly transmitted from the electronic tattoo portion by using a location recognition portion.
